(19) United States
(12) Patent Application Publication
(10) Pub. No.: US 2012/0078787 A1
(43) Pub. Date: Mar. 29, 2012

(54) Mobile Agent Methods and Systems

(75) Inventors: Evans Mehew, Larkspur, CO (US); Kimberly Dunwoody, Parker, CO (US)

(73) Assignee: The Western Union Company, Englewood, CO (US)

(21) Appl. No.: 12/890,296

(22) Filed: Sep. 24, 2010

(51) Int. Cl. G06Q 40/00

(52) U.S. Cl. 705/44; 705/39

(57) ABSTRACT

Methods and systems are described for providing financial services to a disaster area. Biographical information may be received from a disaster victim. A first image may be captured of the disaster victim's face. The first image of the disaster victim's face and the biographical information may be transmitted to a remote server system via wireless communications. The biographical information may be compared to a plurality of biographical records linked to staged financial transactions stored at the remote server system. A match between the biographical information received from the disaster victim and a biographical record of the plurality of biographical records may be identified, wherein the biographical record is linked to a staged financial transaction. An indication of an amount of funds to be distributed may be provided to the disaster victim. The funds may be provided to the disaster victim.

### BACKGROUND OF THE INVENTION

Disasters, both natural and manmade, can wreak havoc on daily tasks that at normal times may be taken for granted. While the ability to access food, water, and shelter may be paramount following a disaster, once these needs are at least temporarily satisfied, a person may need access to money in order to purchase goods and services. However, following a disaster, communication networks and electrical service are often disrupted. For example, while ATMs in a disaster zone may still be physically intact, the ATMs may not be able to communicate with any banking networks due to severed lines or destroyed equipment. Further, the ATM may not have access to power or may not be stocked with cash. Moreover, during the course of the disaster, the person's bank card may have been lost, destroyed, or otherwise made unavailable to the disaster victim, thus rendering access to his bank account via an ATM difficult, if not impossible. Banks may be closed indefinitely due to structural damage, destruction, lack of available employees, lack of security, and/or lack of a sufficient customer base for the bank's opening to make economic sense. Similarly, a person who does not have a bank account may rely on remittances from family members. A money transfer service provider that allows for such money transfers may face service disruptions similar to banks. Some or all of these factors may conspire to limit a disaster victim's access to funds. This inability to access funds may dampen or prevent the disaster victim from access to goods or services that would improve his predicament.

While disasters are one situation where a person's ability to interact with banks, ATMs, or money transfer service providers may be negatively impacted, another situation is where such systems are functioning normally, but a person is unable or unwilling to leave his residence (or other location). The elderly, infirm, shut-ins, and agoraphobics are only a few examples of persons who may not have the ability to interact with financial systems in the way most people can. While these persons may not wish or be able to leave their residences, simple inconvenience, lack of time, and the need for travel may be reasons other persons who would otherwise wish to conduct a financial transaction do not.

### BRIEF SUMMARY OF THE INVENTION

In some embodiments, a method for providing financial services to a disaster area may be provided. The method may include providing a vehicle outfitted with a computer system, at least one user terminal in communication with the computer system, at least one camera in communication with the computer system, and at least one wireless communication interface. The method may include receiving biographical information from a disaster victim. The method may include capturing a first image of the disaster victim's face. The method may include linking the photograph of the disaster victim to the biographical information received from the disaster victim. The method may include transmitting the first image of the disaster victim's face and the biographical information to a remote server system via wireless communications. The method may include comparing the biographical information to a plurality of biographical records linked to staged financial transactions stored at the remote server system. The method may include identifying a match between the biographical information received from the disaster victim and a biographical record of the plurality of biographical records. The biographical record may be linked to a staged financial transaction. The method may include transmitting to the computer system of the vehicle, an indication of an amount of funds to be distributed to the disaster victim. The method may also include providing, to the disaster victim, the amount of funds.

In some embodiments, the method may include receiving a staged financial transaction from a payor, wherein the staged financial transaction comprises an indication of an amount of funds and biographical information of the disaster victim. In some embodiments, the staged financial transaction received by the remote server system from the payor further comprises a second image of the disaster victim. The method may include comparing the first image of the disaster victim taken at the vehicle with the second image of the disaster victim provided by the payor. The comparison may be conducted after the match between the biographical information received from the disaster victim and the biographical record of the plurality of biographical records has been identified. The method may include determining at a confidence level above a threshold level, that the first image of the disaster victim taken at the vehicle and the second image of the disaster victim provided by the payor are images of the disaster victim.

The method may include determining at a confidence level below a threshold level, that the first image of the disaster victim taken at the vehicle and the second image of the disaster victim provided by the payor are images of the disaster victim. The method may include presenting the payor with the first image of the disaster victim taken at the vehicle. The method may include requesting a confirmation from the payor that the first image of the disaster victim taken at the vehicle represents the disaster victim. The method may include receiving prior to providing to the disaster victim the amount of funds, the confirmation from the payor that the first image of the disaster victim taken at the vehicle represents the disaster victim. The amount of funds may be provided in cash to the disaster victim at the vehicle. The vehicle may be equipped with a plurality of wireless communication interfaces, such that if a first wireless communication interface fails, a second of wireless communication interface is used to communicate with the remote server, and at least one of the plurality of wireless communication interfaces comprises satellite communication.

In some embodiments, a system for providing financial services to a disaster area may be present. The system may include a vehicle outfitted with a computer system, at least one user terminal in communication with the computer system, at least one camera in communication with the computer system, and at least one wireless communications interface. The computer system may be configured to: receive, via the user terminal, biographical information from a disaster victim; capture, via the camera, a first image of the disaster victim's face; link the photograph of the disaster victim to the biographical information received from the disaster victim; and transmit the first image and biographical information to a remote server via wireless communications. The system may include a remote server system. The remote server system may be configured to: compare the biographical information to a plurality of biographical records linked to staged financial transactions stored at the remote server; identify a match between the biographical information received from the disaster victim and a biographical record of the plurality of biographical records, wherein the biographical record is linked to a staged financial transaction; and transmit to the computer system of the vehicle, an indication of an amount of funds to be distributed to the disaster victim.

In some embodiments, a computer program product stored on a computer-readable storage medium for providing financial services to a disaster area may be present. The computer program may include instructions for: receiving a staged financial transaction from a payor, wherein the staged financial transaction comprises an indication of an amount of funds, biographical information of a disaster victim, and a first image of the disaster victim; receiving a second image of the disaster victim from a remote computer system; receiving biographical information of the disaster victim from the remote computer system; comparing the biographical information to a plurality of biographical records linked to staged financial transactions stored at the remote server system; identifying a match between the biographical information received from the disaster victim and a biographical record of the plurality of biographical records, wherein the biographical record is linked to a staged financial transaction; and determining at a confidence level below a threshold level that the first image and the second image are of the disaster victim; presenting the payor with the first image of the disaster victim taken at the vehicle; requesting a confirmation from the payor that the first image of the disaster victim taken at the vehicle represents the disaster victim; receiving the confirmation from the payor that the second image of the disaster victim represents the disaster victim; and transmitting, to the remote computer system, an indication of an amount of funds to be distributed to the disaster victim after receiving the confirmation from the payor that the second image of the disaster victim represents the disaster victim.

### BRIEF DESCRIPTION OF THE DRAWINGS

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

The present invention is described in conjunction with the appended figures:

FIG. 1 illustrates a simplified block diagram of an embodiment of a money transfer system.

FIG. 2 illustrates another simplified block diagram of an embodiment of a money transfer system.

FIG. 3 illustrates a simplified block diagram of a mobile response vehicle integrated with a money transfer server system.

FIGS. 4A, 4B, and 4C illustrate a simplified method of conducting a financial transaction using a mobile response vehicle.

FIGS. 5A and 5B illustrate a simplified method of conducting a financial transaction using a third-party agent.

FIG. 6 is a block diagram of an exemplary computer system capable of being used in various embodiments.

### DETAILED DESCRIPTION OF THE INVENTION

A mobile response vehicle, such as a car, truck, ATV, boat, helicopter, or airplane, outfitted with a wireless communication link to one or more financial networks, may be able to travel to a disaster-struck area to improve disaster victims' access to funds. In such an arrangement, a vehicle may create its own power on board (such as through its engine, batteries, and/or a generator) and have one or more end user terminals that allow disaster victims to conduct financial transactions. Because disaster victims may not have access to their bank cards or identification cards, alternative forms of positively identifying disaster victims (also referred to as users), while minimizing fraud may be used. In some embodiments, the user may interact with an end user terminal to provide information necessary to receive a money transfer. The user may provide biographical information and a picture, which may be captured using a camera at the vehicle. The biographical information, along with the picture of the user, may be transmitted to a remote server, which may be part of a money transfer server system.

The vehicle may have one or more different wireless communication links in order to communicate with the remote server. For example, the vehicle may communicate via a typical 3G wireless network, if such a network is available. If such a network is not available, the vehicle may instead use satellite-based communications to communicate with the remote server. Other forms of wireless communication are also possible.

The biographical information received by the remote server may be compared to a database of staged transactions. A staged transaction may have been created by a person (a payor) who wished to send money to the disaster victim. While the payor may have been unable to contact the disaster victim to determine if she is unharmed or in need of help, the payor may be able to set up a financial transaction such that, if the disaster victim interacts with the mobile response vehicle, the disaster victim would be able to access the funds the payor has made available. If the biographical information received from the disaster victim matches (within some margin of error) the biographical information submitted by the payor, the remote server may determine that the disaster victim does have a staged transaction awaiting access.

In order to limit fraud, before the funds associated with the staged transaction are provided to the disaster victim, a comparison of images of the disaster victim may be conducted. The payor may provide a picture of the disaster victim when she stages the transaction such that the picture may be compared with the person presenting himself as the disaster victim at the mobile response vehicle. The image of the disaster victim taken at the emergency response vehicle may then be compared to the image provided by the payor. If the remote server determines that the two images identify the same person, the funds provided by the payor may be provided to the disaster victim at the mobile response vehicle, possibly in the form of a transaction card or cash. If the remote server cannot determine whether the two images are of the same person, or the payor did not provide a picture of the disaster victim, the image of the disaster victim captured at the mobile response vehicle may be sent to the payor for confirmation. For example, the payor may receive an alert to her Smartphone, or an email, to confirm the image of the disaster victim does indeed represent the intended recipient of the funds. If the payor provides confirmation that the funds do represent the disaster victim, the funds may be released to the disaster victim. If not, the transaction may be blocked.

If the disaster victim provides his biographical information and image at the mobile response vehicle and no money transfer has previously been staged by a payor, the disaster victim may send fund requests to prospective payors in order to encourage them to send funds. Such a request may include a request for a certain amount of money, the prospective payor's biographical information and a picture of the disaster victim. This request may then be routed by the remote server to the prospective payor, who may then decide whether to send funds to the disaster victim.

In some embodiments, third-parties are used to provide financial services to persons at their homes (or places of business, or any other place where a person does not have direct access to financial services, but may wish to conduct a transaction). Such third parties may be provided with an end-user terminal (possibly in the form of a tablet computer) that may be presented to users to allow them to conduct financial transactions, whether it be as the person receiving the money (the payee) or the person sending the money (the payor). As one example, mail carriers may be provided with such end-user terminals, thus allowing persons on the mail carrier's delivery route to conduct financial transactions, such as money transfer transactions.

If a user wishes to send funds to another person, the user may request that the third-party agent (such as the mail carrier) present the end-user terminal to the user. The user may then provide all the information necessary to conduct the financial transaction. An image of the user and/or the third-party agent may be taken in association with the financial transaction in order to decrease the chance of fraud. If the user conducts the financial transaction in cash, the cash may be provided to the third-party agent, who may then confirm via the end-user terminal (or some other device) that the funds have been received. The transaction information provided by the user may be transmitted to a remote server to allow the financial transaction to proceed.

If the user wishes to receive funds from another person, the user, again, may request that the third-party present the end-user terminal to the user. The user may then enter a money transfer control number and/or biographical information to the end-user terminal. Based on the information provided by the user, the user may receive funds. The funds may be received electronically, such as directly to a bank account of the user. In some embodiments, the third-party agent may be directed to provide funds in the form of cash to the user. Such transactions, especially such cash transactions, may require the third party to verify his identity and location. For example, the third-party may be required to submit an image of himself before the transaction is completed. In some embodiments, a GPS locator device may be used to confirm that the third-party is located at an address where the recipient of a money transfer transaction resides.

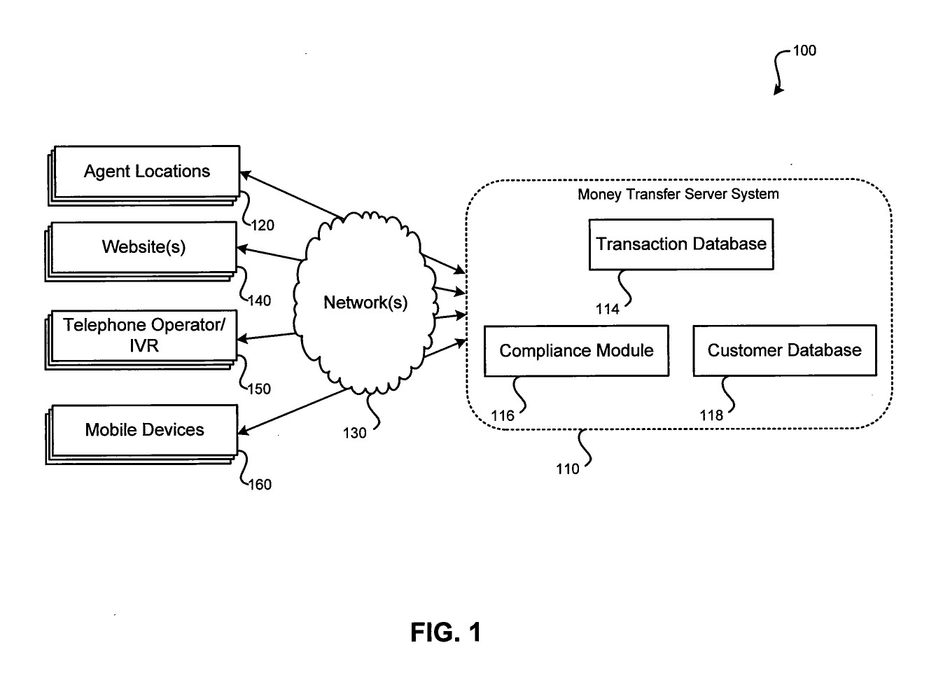

To implement such mobile agent arrangements, a money transfer system may be used. FIG. 1 illustrates a simplified embodiment of a money transfer system 100. Such a money transfer system may be operated by an entity such as WESTERN UNION and may be capable of performing a variety of money transfer transactions from payors to payees. For example, money transfer system 100 may be capable of performing wire transfers and bill payment transactions. Other services may include the ability to issue and reload prepaid stored value cards with funds, and the ability to send gift cards to a party (and reload such cards with funds). A wire transfer may be made from one party to another party, and may involve cash being transferred. Money transfer system 100 may include one or more agent locations 120, one or more websites 140, telephone operator and/or interactive voice response (IVR) systems 150, mobile devices 160, a money transfer server system 110, a transaction database 114, a compliance module 116, and/or a customer database 118.

Agent locations 120 may represent various kiosks and/or other physical locations where payors and payees may conduct money transfer transactions. For example, WESTERN UNION may have hundreds of thousands of agent locations scattered worldwide. At agent locations 120, a person, such as a clerk, may serve as a representative of the entity providing the money transfer service. Payors and payees may conduct money transfer transactions by interacting directly with an agent of the money transfer entity at an agent location. Transactions conducted at an agent location may be conducted using a variety of different payment methods. For example, cash, checks, credit cards, debit cards, and stored value cards are all possible methods through which a payment may be received from a payor or provided to a payee. Also, at an agent location, payors and payees may interact directly with a kiosk that is part of the money transfer system 100. Alternatively, the agent of the money transfer service provider may interact with the kiosk on behalf of the payor or payee.

Money transfer system 100 may include one or more websites. Such websites may allow payors and payees to conduct money transfer transactions via the Internet. A payor may provide payment and transaction information to money transfer system 100 via website 140. For example, a payor may provide bank account information or credit card information to money transfer system 100 via website 140. Likewise, payees may receive payment sent via money transfer system 100 via website 140. For example, it may be possible for a payee to provide a bank account number for funds to be deposited via website 140. Website 140 may also permit a payor or payee to determine the status of a money transfer transaction. If a payor is conducting the money transfer using a bank account, credit card, stored value card, or using some other payment method besides cash, he may be able to conduct the entire payor-side transaction using the website 140. Likewise, if the payee is receiving the funds via a method other than cash, he may be able to complete his payee-side transaction using website 140. Alternatively, if either the payor and payee is conducting the transaction in cash, some of the information necessary to conduct the money transfer transaction may be supplied via website 140, with the cash being transacted at an agent location of agent locations 120.

Money transfer system 100 may also include a telephone operator and/or interactive voice response (IVR) system 150. Telephone operator and/or IVR system 150 may allow a payor and/or payee to conduct the money transfer transaction via a telephone call to the telephone operator and/or IVR system 150. Payors and payees may provide the information necessary to conduct the money transfer transaction via the telephone, either to a human operator, or to an interactive voice response system. If a payor is conducting the money transfer using a bank account, credit card, stored value card, or using some other payment method besides cash, he may be able to completely conduct the transaction using the telephone operator and/or IVR system 150. Likewise, if the payee is receiving the funds via a method other than cash, he may be able to complete the transaction using the telephone operator and/or IVR system 150. Alternatively, if either the payor and payee is conducting the transaction in cash, some of the information necessary to conduct the money transfer transaction may be supplied via the telephone operator and/or IVR system 150, with the cash being transacted at an agent location of agent locations 120.

Also, it may be possible to interact with money transfer system 100 via mobile devices 160. Mobile Device 160 may represent various wireless devices that can communicate with money transfer system 100. For example, Mobile Device 160 may include cellular telephones, smart phones, laptops, tablet computers, etc. Mobile devices 160 may load a website to interact with money transfer system 100. Alternatively, mobile devices 160 may run one or more pieces of software, such as applications or firmware configured to allow interaction with money transfer system 100. Via mobile devices 160, it may be possible for a payor to transmit funds to a payee. Also, it may be possible for a payee to receive funds via mobile devices 160. If a payor is conducting the money transfer using a bank account, credit card, stored value card, or using some other payment method besides cash, the may be able to complete the transaction using a mobile device of mobile devices 160. Likewise, if the payee is receiving the funds via a method other than cash, he may be able to complete the transaction using a mobile device of mobile devices 160. Alternatively, if either the payor and payee is conducting the transaction in cash, some of the information necessary to conduct the money transfer transaction may be supplied via a mobile device of mobile devices 160, with the cash being transacted at an agent location of agent locations 120.

Agent locations 120, website 140, telephone operator and/or IVR system 150, and mobile devices 160 may communicate with money transfer server system 110 via a network 130. Network 130 has been represented as a single network in FIG. 1. This is for simplicity only, network 130 may include several networks. Further, the network used for agent locations 120 to communicate with money transfer server system 110 may be different from the network used by mobile devices 160 to communicate with money transfer server system 110. The network 130 may include one or more public networks, such as the Internet, and one or more private networks, such as a corporate intranet. Further, multiple networks may be used to communicate with money transfer server system 110. For example, mobile devices 160 may use a wireless cellular provider's network and the Internet to communicate with money transfer server system 110.

Whether a payor provides funds to the money transfer system 100 via agent locations 120, website 140, telephone operator and/or IVR system 150, or mobile devices 160, this may not affect how a payee may receive the funds. For example, while a payor may provide funds via website 140, a payee may retrieve the funds via one of agent locations 120. It may also be possible for a payor to use the same entity, such as agent locations 120, to conduct a money transfer transaction.

Money transfer server system 110 may include one or more various subsystems used to conduct a money transfer transaction. For example, a customer database 118 may be present. Customer database 118 may store biographical information about the money transfer service provider's customers (payors and payees).

Transaction database 114 may store information on pending and completed money transfer transactions. Transaction database 114 may identify amounts of funds provided by payors, amounts of funds due to payees, payors' names, the payees' names, transaction identifiers such as money transfer control numbers (MTCNs), the locations where the transactions were initiated (e.g., the website, an address of the agent location), the location of where the transaction is expected to be completed (e.g., where the payee is expected to receive the funds), the payor's payment method (e.g., cash, credit card, money order, stored value card, check, etc.), and whether or not various money transfer transactions have been completed or are pending.

Compliance module 116 may be used to ensure compliance with government regulations. For example, the money transfer service provider operating the money transfer system 100 may be required to comply with various government regulations (possibly varying by country) intended to prevent fraudulent and/or illegal use of money transfer systems. An example of a compliance measure that the money transfer service provider may use is a list of persons that the money transfer service provider is prohibited from doing business with published by the Office of Foreign Asset Control (OFAC). The money transfer service provider may be required by law to not do business with (e.g., as a payor or payee) persons published on such a list. Other compliance measures may include gathering additional information about payors and payees conducting a money transfer that exceeds a particular amount and/or is international. Money transfer transactions being conducted with cash may also include additional compliance measures. Therefore, depending on the location of the payor and payee, the amount of the money transfer, and the payment method, each money transfer may be subject to varying levels of examination and regulation by compliance module 116.

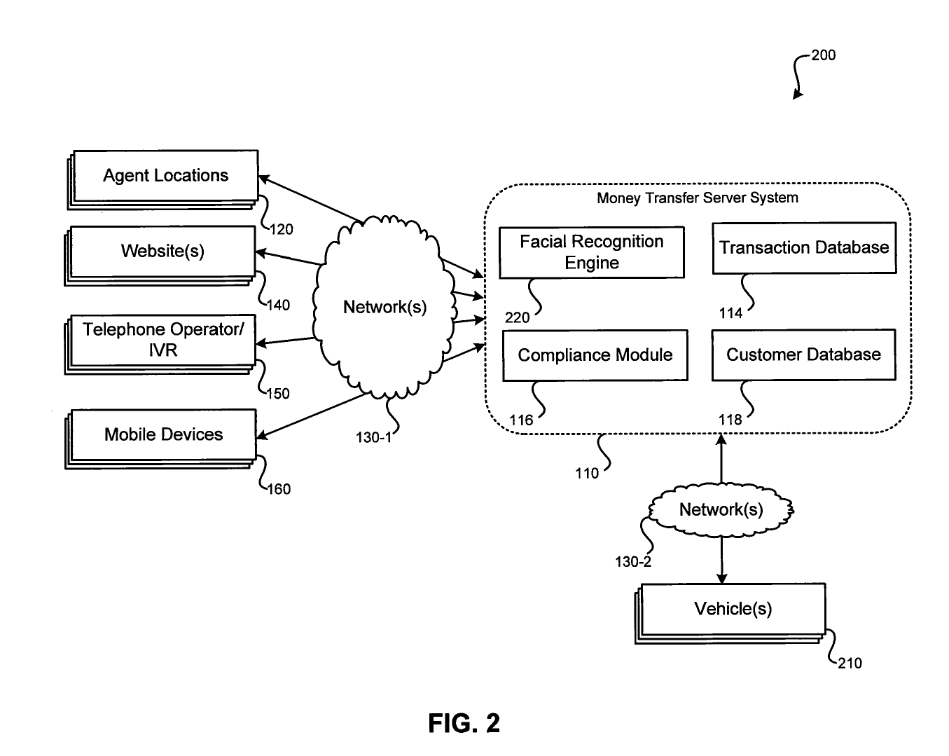

FIG. 2 illustrates another simplified block diagram of an embodiment of a money transfer system 200. Money transfer system 200 may represent the same money transfer system as money transfer system 100 of FIG. 1, or may represent some other money transfer system.

In addition to the previously described interfaces of FIG. 1 (e.g., agent locations 120, website(s) 140, telephone operator/IVR (150), and mobile devices 160), money transfer system 110 may communicate through network 130-2 with one or more vehicles 210. Vehicles 210 may include mobile response vehicles and/or vehicles operated by third party agents. Such vehicles operated by third party agents may include vehicles that are often in the area of potential users. Examples include mail delivery vehicles, package delivery vehicles, newspaper delivery vehicles, utility vehicles (gas, electric, cable, satellite, etc.), government vehicles, etc. In some embodiments, the vehicles may represent vehicles tasked specifically for financial services. For example, a person or entity may equip vehicles primarily for the purpose of going to persons who wish to conduct financial transactions, rather than the financial transactions being a secondary use of the vehicle.

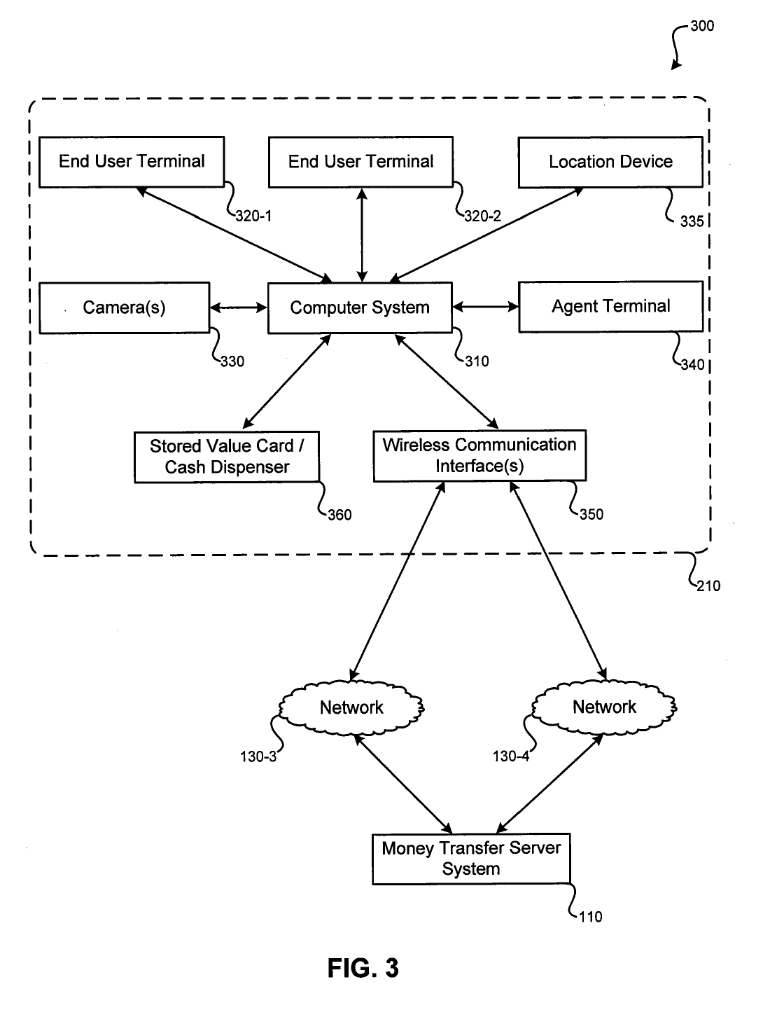

Vehicles 210 may communicate via network(s) 130-2 with money transfer server system 110. Network(s) 130-2 may represent the same or different network(s) from network(s) 130-1. Networks 130-1 and 130-2 may represent network(s) 130 of FIG. 1. Vehicles 210 may be configured to communicate via multiple networks to money transfer server system 110. Such multiple networks are described in greater detail in association with FIG. 3.

Vehicles 210 may be equipped to generate their own power. This may be useful considering that a disaster area may suffer from loss of reliable access to electrical power. Vehicles 210 may use one or more on-board batteries, a generator (which may be the engine of the vehicle), and/or solar arrays to generate electrical power to run the vehicle's systems. Of course, alternate forms of power generation may be possible, such as an external generator which is connected to the vehicle. If electrical power is available in a disaster area, the vehicle may be able to connect to the power source, such as via a standard 110V power cord.

FIG. 3 illustrates a simplified block diagram of a mobile response vehicle integrated with a money transfer server system 300. Vehicle 210 may represent a mobile response vehicle equipped for entering a disaster area. The mobile response vehicle may be a car, truck, airplane, helicopter, boat, ATV, motorcycle, bicycle, etc. Vehicle 210 may also represent a third-party vehicle equipped for allowing users to conduct financial transactions from or near their homes, places of business, or wherever they are located.

Vehicle 210 may be equipped with a computer system 310. Computer system 310 may communicate with one or more end-user terminals. In the embodiment of FIG. 3, two end-user terminals are illustrated: end-user terminal 320-1 and end-user terminal 320-2. While FIG. 3 illustrates two end-user terminals, it should be understood that one, or more than two end-user terminals may also be possible. End-user terminals 320 may be mounted inside or outside of vehicle 210 to allow users, such as disaster victims, to access them. Alternatively, these end-user terminals may be able to be moved a distance from vehicle 210. In some embodiments, end-user terminals 320 are tablet computers. Commercially available tablet computers may be able to be used for such end-user terminals. One example of a possible end-user terminal is an APPLE iPAD. End-user terminals 320 may communicate wirelessly or via wired communication with computer system 310.

One or more cameras 330 may be in communication with computer system 310. Alternatively, cameras 330 may be in communication with end-user terminals 320. In some embodiments, cameras 330 are digital. Cameras 330 may be configured to capture images of the users using end-user terminals 320, especially images of the users' faces. The images captured by cameras 330 may be linked to the information provided by users via end-user terminals 320. As such, fraud may be reduced by the ability to see an image of the person conducting a transaction using end-user terminals 320.

Computer system 310 may also communicate with one or more different wireless communication interfaces 350. Wireless communication interfaces 350 may allow computer system 310 onboard vehicle 210 to communicate with a remote server, which may be part of money transfer server system 110. In order to maximize the likelihood that a connection be established between computer system 310 and the money transfer system 110, multiple wireless communication interfaces 350 may be used. As such, if one or more than one different wireless communication interfaces are unavailable, another wireless communication interface may be used to communicate with money transfer server system 110. As one possible example, wireless communication interfaces 350 may include a cellular telephone network wireless communication interface and a satellite communication interface. Computer system 310 may be configured to first try communicating with money transfer server system 110 via cellular communications. Using a cellular telephone network wireless communication interface, computer system 310 may attempt to communicate with money transfer server system 110 via cellular communication network 130-3. If this communication channel is available, computer system 310 may communicate exclusively via it to money transfer server system 110. If it is not available, or at some point during communication it becomes unavailable, a different communication channel may be used. For example, the computer system 310 may then communicate using a satellite communication interface via satellite network 130-4 with money transfer server system 110. While only two wireless communication interfaces are discussed in relation to FIG. 3, more wireless communication interfaces may be possible. Also, in some embodiments, only one wireless interface, such as a satellite communication interface, may be used to communicate with money transfer server system 110.

Vehicle 210 may be equipped with a location device 335. Location device 335 may be a GPS device or some other form of location determining equipment. Such a location device may be useful to help prevent fraud. For instance, a user may only be able to receive funds if they are located near his residence; this may help to prevent a fraudster, located a great distance away, from acquiring funds destined for a user. Such a location device may also be used to prevent fraud by a third party agent operating the vehicle. It may not be possible for funds to be distributed to a payee unless the vehicle is within a certain distance, such as 200 yards, of the payee's location (e.g., address) as identified by the payor.

Vehicle 210 may also be equipped with an agent terminal 340. Agent terminal 340 may communicate with computer system 310. In some embodiments, agent terminal 340 is part of computer system 310. Agent terminal 340 may allow an agent, such as the driver of vehicle 210, to monitor transactions occurring via end-user terminals 320. Further, agent terminal 340 may allow an agent to conduct various administrative functions and interact with money transfer server system 110. Instructions may also be issued to agent terminal 340. For example, based on information received by agent terminal 340, an agent may dispense stored value cards or cash to users. An instruction received by the agent terminal 340 may indicate that the user using end-user terminal 320-1 has successfully completed a transaction and should receive $50 in cash. The agent may then present the cash to the user.

Computer system 310 may also be in communication with a stored value card and/or cash dispenser 360. After a user has been determined to be eligible to receive a money transfer, the funds may be dispensed by stored value card and/or cash dispenser 360. In some embodiments, stored value card and/or cash dispenser 360 dispenses the funds directly to the user. In some embodiments, stored value card and/or cash dispenser 360 may only be accessed by an agent. The agent may then distribute the stored value card and/or cash to the user. Further, in some embodiments, stored value card and/or cash dispenser 360 may simply be a locked container. This container may be accessed by an agent once it has been determined that a user is due to receive some amount of funds.

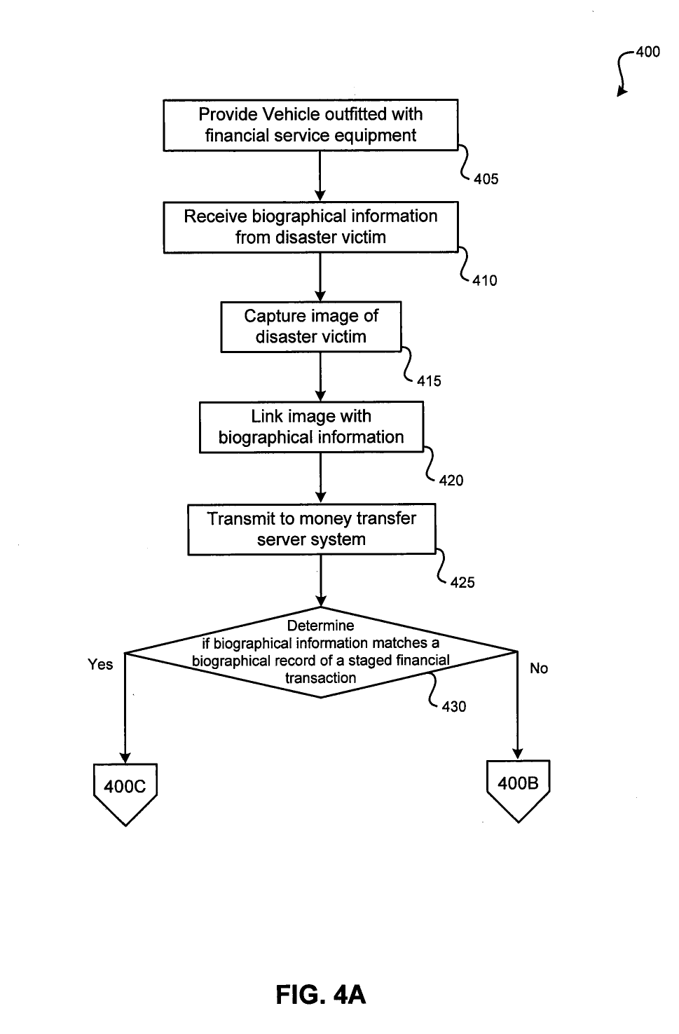

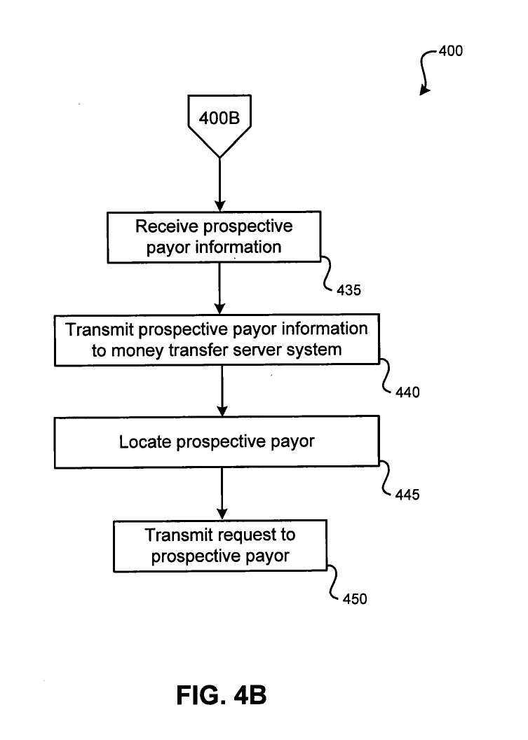

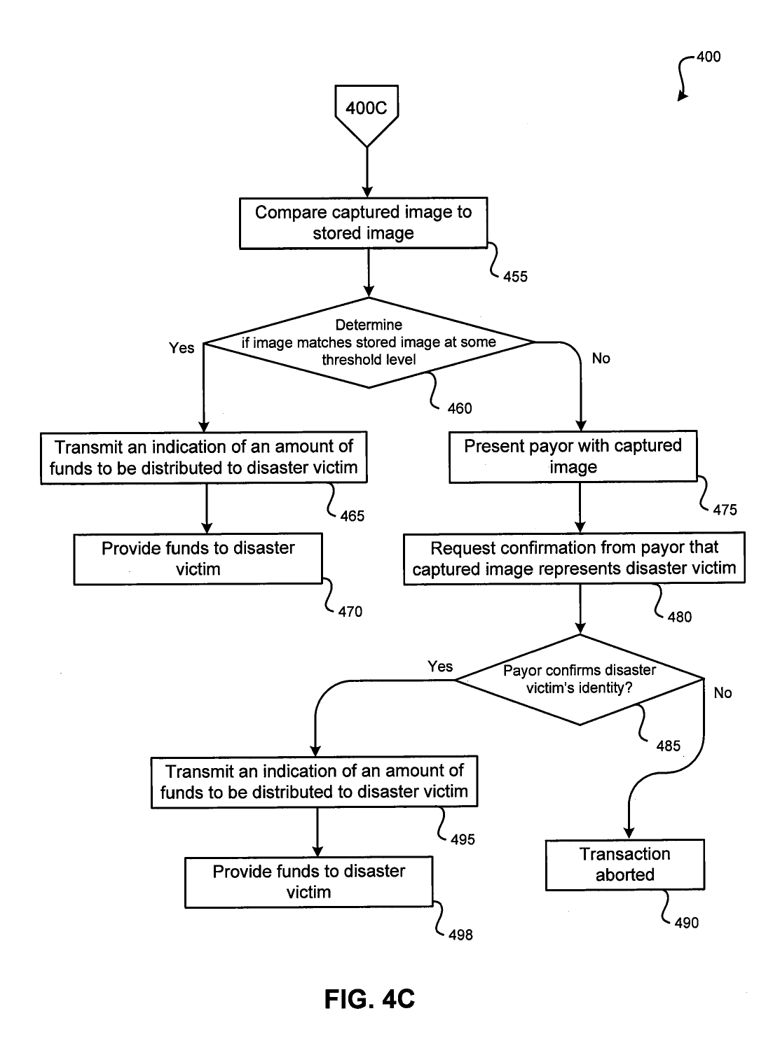

Vehicle 210 in conjunction money transfer system 100 of FIG. 1 or money transfer system 200 of FIG. 2 may permit various methods of financial transactions to be conducted. FIGS. 4A and 4B illustrate a method 400 of conducting a financial transaction using a mobile response vehicle.

At block 405, the vehicle, such as vehicle 210 of FIG. 2 and FIG. 3, may be provided. The vehicle, as previously described, may be outfitted with various financial services equipment. Alternatively, some other vehicle may be used. Whenever and wherever a disaster occurs, such a vehicle may be driven (or flown, piloted, etc., depending on the type of vehicle) to the region of the disaster such that victims of the disaster may use the vehicle to conduct financial transactions. At block 410, a disaster victim may provide biographical information. This biographical information may be provided by the disaster victim to an end-user terminal at the vehicle. The biographical information may include any information useful in identifying the disaster victim. For example, the disaster victim's first name, last name, address, phone number, age, sex, hair color, social security number are various identifiers which may be used.

At block 415, an image of the disaster victim may be captured. The end-user terminal may instruct the disaster victim to look directly into a camera. This camera may then capture one or more images of the disaster victim, possibly of just the disaster victim's face. The image captured of the disaster victim may then be linked with the biographical information collected by the end-user terminal at block 420.

At block 425, the image of the disaster victim, along with the biographical information supplied by the disaster victim to the end-user terminal, may be transmitted to a remote server, such as money transfer server system 110 of FIG. 1 or FIG. 2. The transmission of the biographical information and the image may occur as soon as the disaster victim has supplied each of them, or may be part of a batch transfer that occurs periodically, such as once per hour or once per day from the vehicle to money transfer server system 110.

At block 430, the remote server or the money transfer server system, may determine whether the biographical information supplied by the disaster victim matches the biographical information in the record of a staged financial transaction. Some amount of error may be allowed in the comparison. For example, if the disaster victim's name, and address of the record of the staged financial transaction matches biographical information supplied by the disaster victim, other information, such as the disaster victim's phone number, may be ignored. In some embodiments, all of the biographical information provided by the disaster victim must match the information in the record of the staged financial transaction.

If there is no match between the biographical information supplied by the disaster victim and any of the records of stored financial transactions at the money transfer server system, this most likely means that no payor has attempted to send money to the disaster victim. This, of course, does not mean that no one desires to send money to disaster victim—they simply may not know of a way of helping. To encourage giving to the disaster victim, the disaster victim may be able to create a request that is sent to one or more prospective payors to encourage them to send funds to the disaster victim. Referring to FIG. 4B, at block 435, the disaster victim may provide information about a prospective payor via an end-user terminal. For example, the disaster victim may provide information about a financially solvent relative who is in an area unaffected by the disaster.

Considering that the disaster victim may not have access to any of his records, e-mails, or other methods through which he would typically keep track of his coworkers, friends, contacts and/or relatives, the prospective payor information provided by the disaster victim may tend to be incomplete. For example, a disaster victim may be able to provide the prospective payor's name, and a general address, such as just the prospective payor's city and state and perhaps the street name, but not the exact address. Whatever the case, the information provided by the disaster victim regarding the prospective payor may be transmitted to the money transfer server system at block 440. At block 445, the remote server may use the information provided by the disaster victim to attempt to locate and contact the prospective payor. This may involve searching public records, such as phone books and/or property tax records to attempt to locate the prospective payor. However the prospective payor is located, the money transfer server system may transmit the request to the prospective payor at block 450. For example, if a phone number is located for the prospective payor, he may be called and provided information regarding the disaster victim via a live cell or a recording, with an opportunity to view the picture of the disaster victim. The prospective payor may be given a link to view the picture and description of the disaster victim online, or an identifier to present at an agent location.

If the prospective payor ignores the request, nothing may happen. However, if the prospective payor decides to send funds, the payor may stage a money transfer transaction to the disaster victim using any of the interfaces discussed in relation to FIGS. 1 and 2. The payor may identify an amount of funds, an identifier of the request received from the disaster victim, biographical information of the disaster victim, and/or a source of funds. Unless provided in the form of cash at an agent location, the funds may not be withdrawn from an account of the payor unless the disaster victim retrieves the funds at the mobile response vehicle or some other mobile response vehicle. If the payor provides cash, he may be able to receive at least a partial refund if the disaster victim does not retrieve the funds. If the payor is providing funds in response to a request from the disaster victim, he likely will have already been presented with a captured image of the disaster victim. As such, the payor may not need to provide an additional image of the payor for confirmation. Rather, when (and if) the disaster victim returns to a mobile response vehicle to retrieve the funds, the earlier captured image of the disaster victim may be compared to a new captured image of the disaster victim to determine whether the person who sent the request to the payor is the same person as the person attempting to retrieve the funds.

Returning to block 430 of FIG. 4A, if it is determined that the biographical information matches a biographical record of a staged financial transaction, method 400 may proceed to block 455 of FIG. 4C. At block 455, the image of the disaster victim captured at the mobile response vehicle may be compared to another image, possibly provided by the payor. If the payor did not provide an image of the disaster victim, this step may be skipped and the method may proceed to block 475. Also, as detailed above, if the staged financial transaction is in response to an earlier request to a prospective payor, the images compared may be the image of the disaster victim captured when the request to the prospective payor was made and an image captured when the funds are attempted to be retrieved.

At block 460, the two images (whether both received via the mobile response vehicle, or one received at the mobile response vehicle and one provided by the payor) may be compared. Facial recognition software may be able to determine whether the two images represent the same person to a certain degree of confidence. If the confidence level is above some threshold level, the money transfer server system may assume that the two images represent the same person. If this occurs, no further input may be required from the payor in order for the funds to be released to the disaster victim. At block 465, the disaster victim (and possibly an agent at the mobile response vehicle) would receive an indication of an amount of funds. The amount of funds, or the amount of funds minus a service fee, may be provided to the disaster victim in an appropriate form, possibly selected by the disaster victim, at block 470. While a stored value card or debit card may be more convenient and safer, cash may be necessary because of the inability to conduct transactions using a transaction card (such as due to downed networks or lack of electricity) in the vicinity of the disaster.

Returning to block 460, if the images are not determined to match at or above the threshold level, this does not necessarily mean that the funds will be blocked from being distributed to the disaster victim. Due to the disaster (e.g., injuries, dirt), or natural aging, changes in facial hair, hair color, etc., the two images may not be good matches. In such a situation, the payor may be presented with the opportunity to determine whether the captured image of the disaster victim indeed represents the person who the payor wishes to distribute funds to. Additionally, if the payor did not provide an image of the disaster victim, and an earlier image was of the disaster victim was not presented to the payor, the payor may automatically be presented with an image of the disaster victim for confirmation. At block 475, the payor may be presented with the image captured at the mobile response vehicle. The image may be presented to the payor via several of the interfaces present in FIGS. 1 and 2. For example, the payor may view the captured image of the disaster victim via a webpage of the money transfer service provider or may receive an email containing the photograph from the money transfer service provider. The payor may also go to an agent location of the money transfer service provider, where he may be able to view the captured image of the disaster victim. Further, the payor may be able to receive the image of the disaster victim directly to a mobile device, such as a Smartphone. At block 480, a request for confirmation that the captured image is indeed the disaster victim that the payor intends to distribute funds to may be presented to the payor. At block 485, the payor may confirm whether the image does or does not represent the disaster victim's identity. This confirmation by the payor may be possible in real time, such that the disaster victim has his image captured at the mobile response vehicle and can retrieve funds, if available, within seconds or minutes, assuming that the payor confirms the disaster victim's identity, if necessary. If, at block 460, the money transfer server system determines that the images match to a confidence level above the threshold level, the disaster victim may be able to receive the funds sent by the payor instantly or near instantly.

If the payor responds that the captured image does not represent the intended recipient of the funds, the transaction is aborted at block 490. The disaster victim may be notified that he will not be receiving funds. Also, the captured image of the disaster victim may be flagged as a potential fraudster and may be banned from conducting future transactions using the mobile response vehicle. If the payor responds that the captured image does represent the intended recipient, the disaster victim (and possibly an agent at the mobile response vehicle) would receive an indication of an amount of funds to be distributed to the disaster victim at block 495. That amount of funds, or the amount of funds minus a service fee, may be provided to the disaster victim in an appropriate form, possibly selected by the disaster victim, at block 498.

While method 400 depicted in FIGS. 4A-4C details a disaster situation, money transfers may also be provided on-location in non-emergency situations. For example, a person may wish to conduct (e.g., as the payor or payee) a money transfer transaction, but may be unwilling or unable to leave his current location, be it his home, workplace, hospital bed, nursing home, homeless shelter, etc. In order to reach such potential customers, third-party agents may be equipped with access to the money transfer system. Such an arrangement may allow for the third-party agent (a third-party agent being a person not employed by the money transfer service provider, but providing services on their behalf) to continue their typical day-to-day operations while providing money transfer services. For example, a mail carrier may typically visit scores of homes per day. The mail carrier may continue to deliver mail, but may also carry a computerized system allowing persons along her mail route to conduct money transfer transactions. Besides mail carriers, persons such as bike couriers, utility workers, package delivery employees, newspaper delivery agents, police officers, grocery delivery persons, or any other person who typically visits persons may be equipped with a money transfer transaction computer.

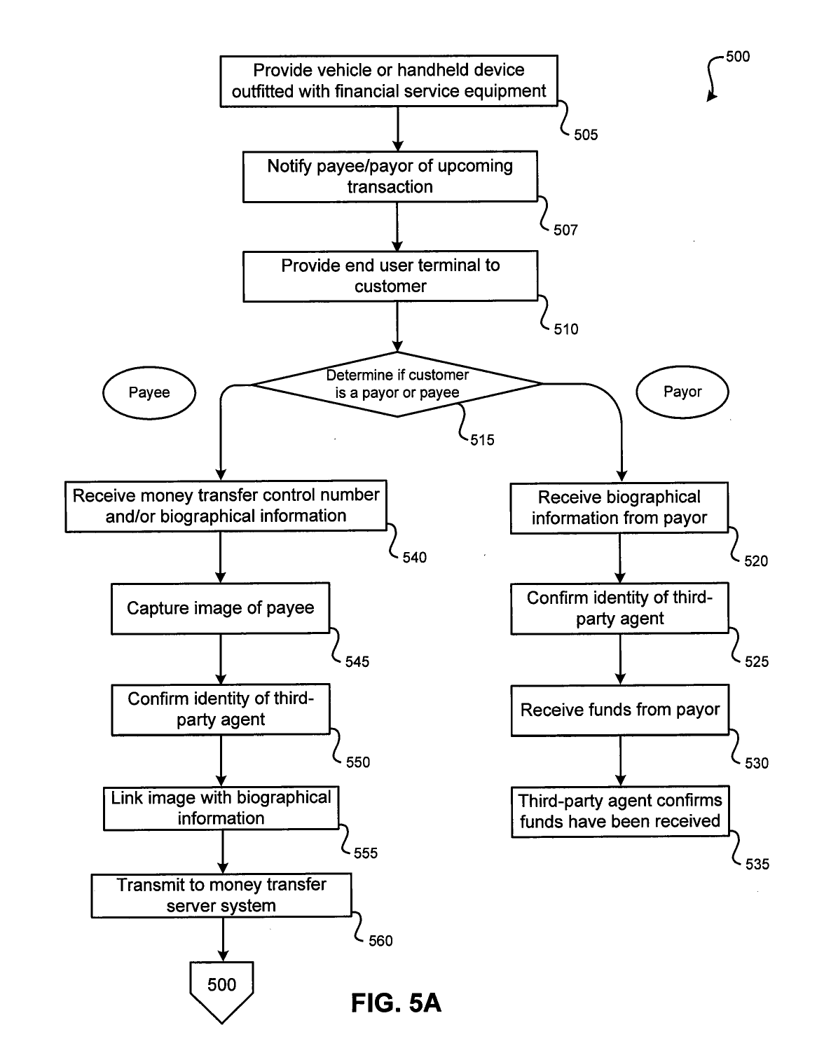

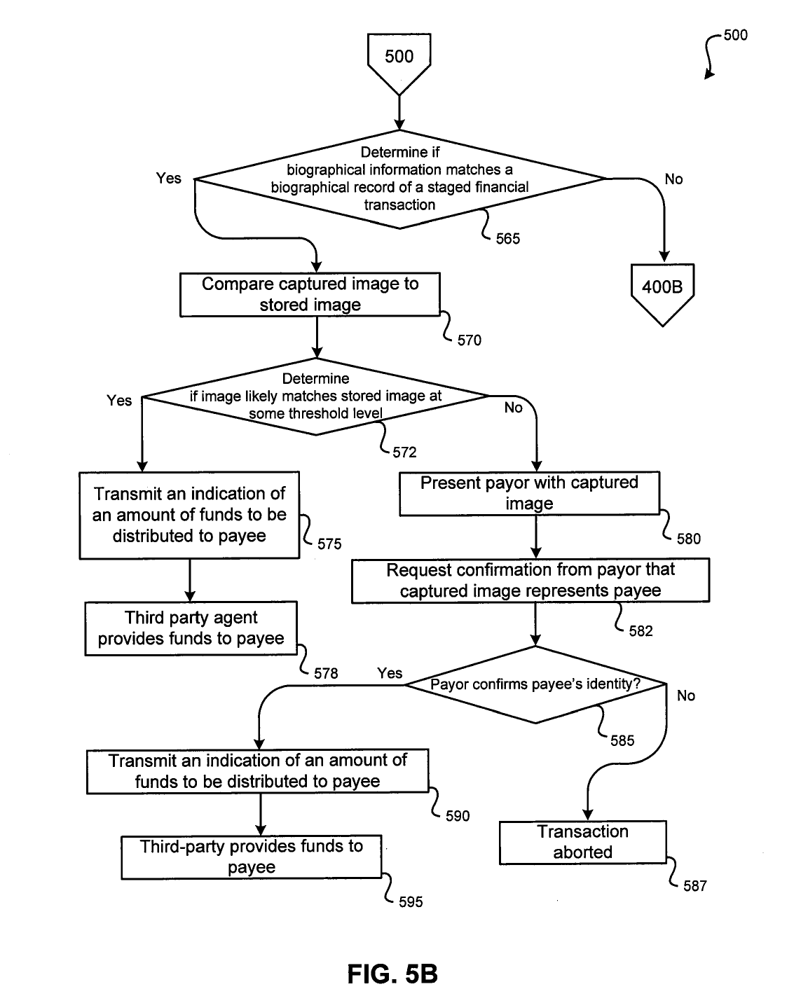

Method 500, which begins on FIG. 5A, illustrates a simplified method of conducting a financial transaction using third-party agents. Such a method may be performed using the money transfer systems of FIG. 1 or 2 (or some other money transfer system), along with a vehicle equipped to conduct a money transfer transaction, such as that presented in FIG. 3. In some embodiments, the equipment to conduct money transfer transactions is contained in a device capable of being carried such that the device may be brought to the user, such as in the form of a laptop or tablet computer. Such a device may be provided at block 505.

At block 507, the payee and/or the payor may be notified of an impending transaction. The payor may be notified that the third-party agent will be in the area of the payee on a certain date, between certain times and that the payor should make herself available in case the payor is required to positively identity the payee. Similarly, the payee may be notified that the third party will be in the area of the payee on a certain date between certain times, and that if the payee wishes to receive the funds, should make herself available during those times. At block 510, whether the device to access the money transfer system is mounted to a vehicle or is handheld, the device may be presented to the user. This may involve the user traveling to the vehicle, or may involve the third-party agent traveling to the physical location of the user with a handheld device.

At block 515, whether at the vehicle or using a handheld device, the user may indicate whether he is attempting to receive a money transfer (as a payee) or is attempting to send a money transfer (as a payor). If the user identifies that he is a payor, the method may proceed to block 520. At block 520, the user may present biographical information to identify himself. The user may provide biographical information relating to both himself and the intended payee. This biographical information may include a picture of the intended payee (possibly a disaster victim) or any other person being provided. The device used by the user may include a camera or a scanner to capture such a picture of the intended payee.

In order to ensure that no fraud is occurring, whenever a money transfer transaction is created, the third party agent may be required to have his identity confirmed. For example, at block 525, for each money transfer transaction, the third-party agent may be required to take a picture of himself. Alternatively, the third-party agent may be required to scan a barcode and/or enter a password. Of course, other forms of identity confirmation are possible, including biometrics.

At block 530, the funds may be received from the payor. If in cash, the funds may be received by the third-party agent. If electronically, the payor may directly enter a transaction card number or account number into the handheld device or device attached to the vehicle. If the funds are received by the third-party agent in cash, at block 535, the third-party may confirm with the money transfer system, possibly using the device attached to the vehicle or the handheld device, that the funds have been received in cash.

Returning to block 515, if the customer identifies himself as a payee, the identity of the payee may be confirmed much as the disaster victim's identity is confirmed in method 400. If the customer identifies himself as a payee, presumably a payor has already initiated a money transfer transaction using one of the interfaces discussed in relation to FIGS. 1 and 2. At block 540, the payee may provide biographical information to identify himself. Alternatively, the payee may have received a money transfer control number (MTCN) from the payor. If a MTCN is used, the customer's identity may or may not also be confirmed.

If the payee's identity is to be confirmed, an image of the payee may be captured at block 545. The identity of the third-party agent may be captured at block 550. This may involve an image of the third-party agent being captured. Other methods of confirming the identity of the third-party agent may be performed, such as those described in relation to block 525. At block 555, the image of the payee may be linked with the biographical information (and/or the MTCN) that the payee provided. The picture, biographical information, and/or the MTCN may be transmitted to the money transfer server system at block 560. If a handheld device is in use, the information may be relayed to the vehicle, which may then send it to the money transfer server system, or, alternatively, the handheld device may send it directly to the money transfer system via a wireless network.

Continuing with method 500 on FIG. 5B, at block 565, the biographical information or the MTCN may be used to determine if a biographical record of a staged financial transaction is intended for the payee. If not, the method may continue by following the steps as described in FIG. 4B, thus allowing the payee to send a request to a prospective payor. It should be understood that the payee does not need to first attempt to receive a money transfer before sending a request to a prospective payor. Rather, if the payee is not expecting to receive a money transfer, he may just use the handheld device or device mounted to the vehicle to directly send a request for a money transfer to a prospective payor.

Returning to block 565, if the biographical information provided by the payee matches the biographical information of a staged financial transaction, method 500 may proceed to block 570. At block 570, the image of the payee captured at block 545 may be compared with an image supplied by the payor. Facial recognition software may be able to determine whether the two images represent the same person to a certain degree of confidence at block 572. The confidence level required to determine if a match is present may vary depending on the amount of funds being transferred. For example, if greater than a thousand dollars, an almost certain likelihood of a match may be required, while if only $50 is being transferred, a 90% chance of a match may be sufficient. Whatever the threshold, if the confidence level is above the threshold level, the money transfer server system may determine that the two images represent the same person and the method may proceed to block 575. If this occurs, no further input may be required from the payor in order for the funds to be released to the payee. At block 575, the payee (and possibly the third-party agent) may receive an indication of an amount of funds. That amount of funds, or the amount of funds minus a service fee, may be provided to the payee in an appropriate form, possibly selected by the payor or payee, at block 578. The form of the funds may be cash paid out by the third-party agent. The form of cash may also involve a stored value card or debit card being given by the third-party agent to the payee. In some embodiments, if the third-party agent is delivering a stored value card to the home or place of business of the payee, it may be possible for the third-party agent to leave the transaction card for the payee, and allow the payee to activate the transaction card via an interface of the money transfer service provider. For example, the payee may be able to activate the stored value card via a website of the money transfer service provider. This may involve the payee providing biographical information, a MTCN, and/or a picture of himself to the money transfer service provider via the website. Other interfaces, such as those detailed in relation to FIGS. 1 and 2 may also be used to activate the transaction card. The payout to the payee may also be made directly to a m-wallet (mobile wallet). This may involve the handheld device or device mounted to the vehicle communicating directly with the device (e.g., Smartphone) of the payee that contains the m-wallet. This may also serve as a layer of fraud protection because it may be possible to confirm that the m-wallet the funds are transferred to is registered to the payee designated by the payor.

Returning to block 572, if the images are not determined to match above the threshold level, this does not automatically mean that the funds will be blocked from being distributed to the payee. In such a situation, the payor may be presented with the opportunity to determine whether the capture image of the payee indeed represents the person who the payee wishes to distribute funds to. Also, if no earlier image of the payee was provided by the payor, block 580 may automatically be performed. If a request for money was sent to the payor and contained an image, this image may be used. At block 580, the payor may be presented with the image captured at the device attached to the vehicle or the handheld device. The image may be presented to the payor via several of the interfaces present in FIGS. 1 and 2. For example, the payor may view the captured image of the payee via a webpage of the money transfer service provider or may receive an email containing the photograph from the money transfer service provider. The payor may also go to an agent location of the money transfer service provider, where he may be able to view the captured image of the payee. Further, the payor may be able to receive the image of the payee directly to a mobile device, such as a Smartphone. At block 582, a request for confirmation that the captured image is the intended payee that the payor intends to distribute funds to may be sent to the payor. At block 585, the payor may confirm the whether the image does or does not represent the payee. This confirmation by the payor may be possible in real time, such that the third-party waits with the payee for an amount of time to see if the payor responds. The response may be forwarded to the handheld device or the device attached to the vehicle.

If the payor responds that the captured image does not represent the intended recipient of the funds, the transaction is aborted at block 587. The payee may be notified that he will not be receiving funds. Also, the captured image of the payee may be flagged as an image of a potential fraudster and this payee may be banned from conducting future transactions using the third-party agent money transfer system. If the payor responds that the captured image does represent the intended payee, the payee (and possibly the third-party agent) would receive an indication of an amount of funds to be distributed to the payee at block 590. That amount of funds, or the amount of funds minus a service fee, may be provided to the payee in an appropriate form, possibly selected by the payee, at block 595.

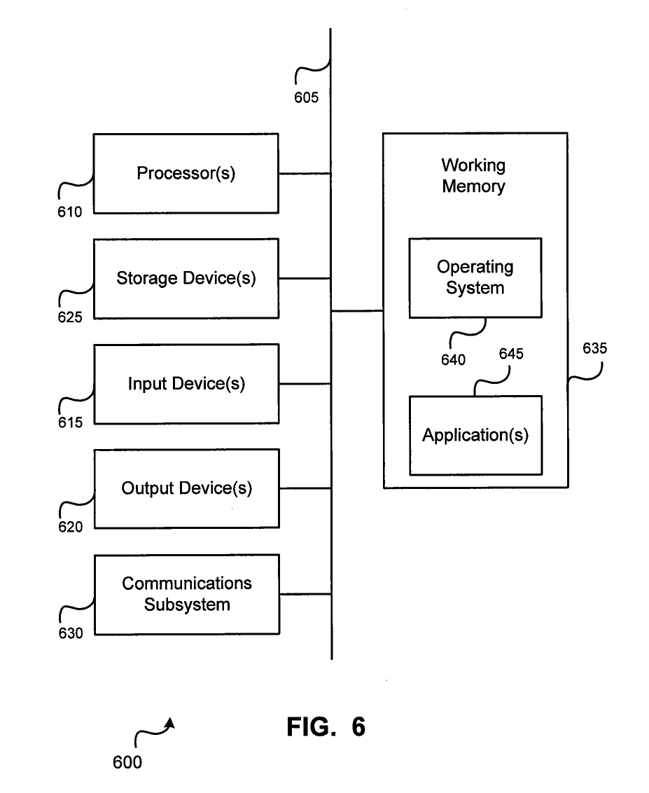

To perform the actions of the money transfer system, the various components of the money transfer system, the computer system of the mobile response vehicle, the handheld device, or any other previously mentioned computing devices, a computer system as illustrated in FIG. 6 may be used. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Further, while the preceding description details money transfer transactions, it should be understood that similar systems and methods may be used to perform other forms of financial transactions. For example, similar arrangements may be used to conduct withdrawals from bank accounts, conduct bill payment transactions, send and receive gift cards, etc.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for providing financial services to a disaster area, the method comprising:
providing a vehicle outfitted with a computer system, at least one user terminal in communication with the computer system, at least one camera in communication with the computer system, and at least one wireless communication interface;
receiving, by the user terminal, biographical information from a disaster victim;
capturing, by the camera, a first image of the disaster victim's face;
linking the photograph of the disaster victim to the biographical information received from the disaster victim;
transmitting, by the computer system, the first image of the disaster victim's face and the biographical information to a remote server system via wireless communications;
comparing, by the remote server system, the biographical information to a plurality of biographical records linked to staged financial transactions stored at the remote server system;
identifying, by the remote server system, a match between the biographical information received from the disaster victim and a biographical record of the plurality of biographical records, wherein the biographical record is linked to a staged financial transaction;
transmitting, by the remote server system, to the computer system of the vehicle, an indication of an amount of funds to be distributed to the disaster victim; and
providing, to the disaster victim, the amount of funds.

2. The method of claim 1, further comprising receiving, by the remote server system, a staged financial transaction from a payor, wherein the staged financial transaction comprises an indication of an amount of funds and biographical information of the disaster victim.

3. The method of claim 2, wherein the staged financial transaction received by the remote server system from the payor further comprises a second image of the disaster victim.

4. The method of claim 3, further comprising comparing, by the remote server system, the first image of the disaster victim taken at the vehicle with the second image of the disaster victim provided by the payor, wherein the comparison is conducted after the match between the biographical information received from the disaster victim and the biographical record of the plurality of biographical records has been identified.

5. The method of claim 4, further comprising determining, by the remote server system, at a confidence level above a threshold level, that the first image of the disaster victim taken at the vehicle and the second image of the disaster victim provided by the payor are images of the disaster victim.

6. The method of claim 4, further comprising:
determining, by the remote server system, at a confidence level below a threshold level, that the first image of the disaster victim taken at the vehicle and the second image of the disaster victim provided by the payor are images of the disaster victim;
presenting, by the remote server system, the payor with the first image of the disaster victim taken at the vehicle;
requesting, by the remote server system, a confirmation from the payor that the first image of the disaster victim taken at the vehicle represents the disaster victim; and
receiving, by the remote server system, prior to providing to the disaster victim the amount of funds, the confirmation from the payor that the first image of the disaster victim taken at the vehicle represents the disaster victim.

7. The method of claim 1, wherein the amount of funds is provided in cash to the disaster victim at the vehicle.

8. The method of claim 1, wherein the vehicle is equipped with a plurality of wireless communication interfaces, such that if a first wireless communication interface fails, a second of wireless communication interface is used to communicate with the remote server, and at least one of the plurality of wireless communication interfaces comprises satellite communication.

9. A system for providing financial services to a disaster area, the system comprising:
a vehicle outfitted with a computer system, at least one user terminal in communication with the computer system, at least one camera in communication with the computer system, and at least one wireless communications interface, wherein the computer system is configured to:
receive, via the user terminal, biographical information from a disaster victim;
capture, via the camera, a first image of the disaster victim's face;
link the photograph of the disaster victim to the biographical information received from the disaster victim; and
transmit the first image and biographical information to a remote server via wireless communications; and
a remote server system, wherein the remote server system is configured to:
compare the biographical information to a plurality of biographical records linked to staged financial transactions stored at the remote server;
identify a match between the biographical information received from the disaster victim and a biographical record of the plurality of biographical records, wherein the biographical record is linked to a staged financial transaction; and
transmit to the computer system of the vehicle, an indication of an amount of funds to be distributed to the disaster victim.

10. The system of claim 9, wherein the remote server system is further configured to receive a staged financial transaction from a payor, wherein the staged financial transaction comprises an indication of an amount of funds and biographical information of the disaster victim.

11. The system of claim 10, wherein the staged financial transaction received by the remote server system from the payor further comprises a second image of the disaster victim.

12. The system of claim 11, wherein the remote server system is further configured to compare the first image of the disaster victim taken at the vehicle with the second image of the disaster victim provided by the payor, wherein the comparison is conducted after the match between the biographical information received from the disaster victim and the biographical record of the plurality of biographical records has been identified.

13. The system of claim 12, wherein the remote server is further configured to determine at a confidence level above a threshold level that the first image of the disaster victim taken at the vehicle and the second image of the disaster victim provided by the payor are images of the disaster victim.

14. The system of claim 12, wherein the remote server is further configured to:
determine at a confidence level below a threshold level that the first image of the disaster victim taken at the vehicle and the second image of the disaster victim provided by the payor are images of the disaster victim;
transmit to the payor the first image of the disaster victim taken at the vehicle;
request a confirmation from the payor that the first image of the disaster victim captured at the vehicle represents the disaster victim; and
receive, prior to providing to the disaster victim the amount of funds, the confirmation from the payor that the first image of the disaster victim taken at the vehicle represents the disaster victim.

15. The system of claim 9, wherein the remote server is further configured to transmit a response to the vehicle's computer system indicating that no staged financial transaction is present a the remote server for the disaster victim.

16. The system of claim 9, wherein:
the vehicle's computer system is further configured to:
receive a prospective payor's biographical information and an indication of an amount of funds from the disaster victim; and
transmit the prospective payor's biographical information to the remote server; and
the remote server is further configured to:
receive the prospective payor's biographical information from the computer system; and
transmit to the prospective payor a request for the amount of funds, wherein the request includes the first image of the disaster victim and the biographical information of the disaster victim.

17. A computer program product stored on a computer-readable storage medium for providing financial services to a disaster area, the computer program product comprising instructions for:
receiving a staged financial transaction from a payor, wherein the staged financial transaction comprises an indication of an amount of funds, biographical information of a disaster victim, and a first image of the disaster victim;
receiving a second image of the disaster victim from a remote computer system;
receiving biographical information of the disaster victim from the remote computer system;
comparing the biographical information to a plurality of biographical records linked to staged financial transactions stored at the remote server system;
identifying a match between the biographical information received from the disaster victim and a biographical record of the plurality of biographical records, wherein the biographical record is linked to a staged financial transaction; and
determining at a confidence level below a threshold level that the first image and the second image are of the disaster victim;
presenting the payor with the first image of the disaster victim taken at the vehicle;
requesting a confirmation from the payor that the first image of the disaster victim taken at the vehicle represents the disaster victim;
receiving the confirmation from the payor that the second image of the disaster victim represents the disaster victim; and
transmitting, to the remote computer system, an indication of an amount of funds to be distributed to the disaster victim after receiving the confirmation from the payor that the second image of the disaster victim represents the disaster victim.

18. The computer program product of claim 17, wherein the payor is presented with the first image of the disaster victim taken at the vehicle in real time or near real time.

19. The computer program product of claim 17, wherein the staged financial transaction is staged by the payor at an agent location of a money transfer service provider that operates the remote computer system.

20. The computer program product of claim 17, wherein the staged financial transaction comprises a request for visual evidence that the disaster victim receives the amount of funds.
